(19) United States
(12) Patent Application Publication
(10) Pub. No.: US 2025/0254103 A1
(43) Pub. Date: Aug. 7, 2025

(54) COMMUNICATION METHOD

(71) Applicant: KYOCERA Corporation, Kyoto (JP)

(72) Inventor: Mitsutaka HATA, Yokohama-shi (JP)

(73) Assignee: KYOCERA Corporation, Kyoto (JP)

(21) Appl. No.: 19/187,096

(22) Filed: Apr. 23, 2025

Related U.S. Application Data
(63) Continuation of application No. PCT/JP2023/037228, filed on Oct. 13, 2023.

(30) Foreign Application Priority Data
Oct. 25, 2022 (JP) 2022-170700

(51) Int. Cl. H04L 41/16; H04W 12/03; H04W 12/041; H04W 12/0431

(52) U.S. Cl. CPC H04L 41/16; H04W 12/03; H04W 12/041; H04W 12/0431

(57) ABSTRACT

The present disclosure relates to a communication method in a mobile communication system. The communication method includes a step of transmitting, by a first user equipment, training data and/or inference data to a network apparatus. The communication method includes a step of deleting, by the network apparatus, security target data and/or privacy target data from the training data and/or the inference data. The communication method includes a step of transmitting, by the network apparatus, the training data after deletion and/or the inference data after deletion to a second user equipment. The communication method includes a step of performing, by the second user equipment, machine learning using the training data after deletion and/or the inference data after deletion.

### RELATED APPLICATIONS

The present application is a continuation based on PCT Application No. PCT/JP2023/037228, filed on Oct. 13, 2023, which claims the benefit of Japanese Patent Application No. 2022-170700 filed on Oct. 25, 2022. The content of which is incorporated by reference herein in their entirety.

### TECHNICAL FIELD

The present disclosure relates to a communication method.

### BACKGROUND

In recent years, in the Third Generation Partnership Project (3GPP) (registered trademark), which is a standardization project for mobile communication systems, a study is underway to apply an Artificial Intelligence (AI) technology, particularly, a Machine Learning (ML) technology to wireless communication (air interface) in the mobile communication system.

### CITATION LIST

### Non-Patent Literature

Non-Patent Document 1: 3GPP Contribution RP-213599, “New SI: Study on Artificial Intelligence (AI)/Machine Learning (ML) for NR Air Interface”

### SUMMARY

In an aspect, a communication method is a communication method in a mobile communication system. The communication method includes a step of transmitting, by a first user equipment, training data and/or inference data to a network apparatus. The communication method includes a step of deleting, by the network apparatus, security target data and/or privacy target data from the training data and/or the inference data. The communication method includes a step of transmitting, by the network apparatus, the training data after deletion and/or the inference data after deletion to a second user equipment. The communication method includes a step of performing, by the second user equipment, machine learning using the training data after deletion and/or the inference data after deletion.

A communication method according to an aspect is a communication method in a mobile communication system. The communication method includes a step of receiving, by a network apparatus, training data and/or inference data from a first user equipment. The communication method includes a step of requesting, by the network apparatus, a public key from the second user equipment. The communication method further includes a step of transmitting, by the second user equipment, a public key created from a private key in the machine learning model to the network apparatus in response to the requesting. The communication method includes a step of encrypting, by the network apparatus, the training data and/or the inference data using the public key, and transmitting the encrypted training data and/or the encrypted inference data to the second user equipment. The communication method includes a step of decrypting, by the machine learning model of the second user equipment, the encrypted training data and/or the encrypted inference data using the private key, and performing machine learning using the decrypted training data and/or the decrypted inference data.

A communication method according to an aspect is a communication method in a mobile communication system. The communication method includes a step of encrypting, by a first machine learning model of a first user equipment, training data and/or inference data using a common key. The communication method includes a step of transmitting, by the first user equipment, the encrypted training data and/or the encrypted inference data to the network apparatus. The communication method includes a step of transmitting, by the network apparatus, the encrypted training data and/or the encrypted inference data to the second user equipment. The communication method includes a step of decrypting, by a second machine learning model of the second user equipment, the encrypted training data and/or the encrypted inference data using the common key, and performing machine learning using the decrypted training data and/or the decrypted inference data.

A communication method according to an aspect is a communication method in a mobile communication system. The communication method includes a step of transmitting, by a network apparatus, a program for executing machine learning to a first user equipment and a second user equipment. The communication method includes a step of encrypting, by the first user equipment, training data and/or inference data using a common key created from the program, and transmitting the encrypted training data and/or the encrypted inference data to the network apparatus. The communication method includes a step of transmitting, by the network apparatus, the encrypted training data and/or the encrypted inference data to the second user equipment. The communication method includes a step of decrypting, by the second user equipment, the encrypted training data and/or the encrypted inference data using the common key created from the program, and performing machine learning using the decrypted training data and/or the decrypted inference data.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a base station (gNB) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of the AI/ML technology according to the first embodiment.

FIG. 7 is a diagram illustrating a configuration example of a mobile communication system according to the first embodiment.

FIGS. 8A and 8B are diagrams illustrating an example in which learning inference data is deleted according to the first embodiment.

FIG. 9 is a diagram illustrating an example of a configuration of a UE and a gNB according to the first embodiment.

FIG. 10 is a diagram illustrating an example of a configuration of the UE and the gNB according to the first embodiment.

FIG. 11 is a diagram illustrating an example of an operation according to the first embodiment.

FIG. 12 is a diagram illustrating an example of a configuration of the UE and the gNB according to the first embodiment.

FIG. 13 is a diagram illustrating an example of a configuration of the UE and the gNB according to the first embodiment.

FIG. 14 is a diagram illustrating an example of a configuration of the UE and the gNB according to the first embodiment.

FIG. 15 is a diagram illustrating an example of a configuration of the UE and the gNB according to the first embodiment.

FIG. 16 is a diagram illustrating an example of a configuration of a mobile communication system according to a second embodiment.

FIG. 17 is a diagram illustrating a first operation example according to the second embodiment.

FIG. 18 is a diagram illustrating a second operation example according to the second embodiment.

FIG. 19 is a diagram illustrating an example of program transmission according to a third embodiment.

FIG. 20 is a diagram illustrating an operation example according to the third embodiment.

### DESCRIPTION OF EMBODIMENTS

When a machine learning technology is applied to a mobile communication system, how to utilize the machine learning technology has not yet been established. In particular, how to apply machine learning when data used in machine learning is security target data or privacy target data has not been established.

An object of the present disclosure is to make it possible to ensure security or privacy in machine learning in a mobile communication system.

### First Embodiment

A mobile communication system according to a first embodiment will be described with reference to the drawings. In the description of the drawings, the same or similar parts are denoted by the same or similar reference signs.

### Configuration of Mobile Communication System

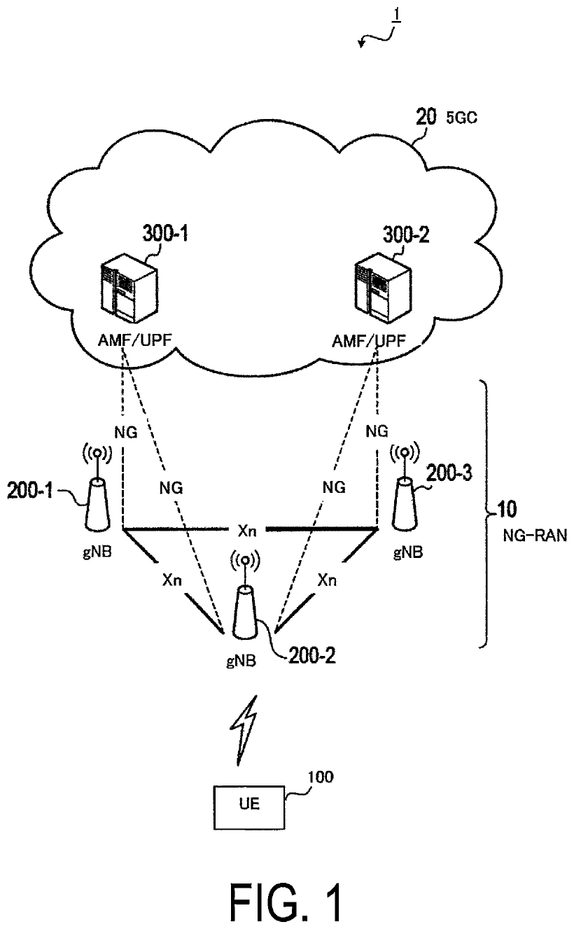

A configuration of a mobile communication system according to a first embodiment will be described. FIG. 1 is a diagram illustrating a configuration example of the mobile communication system 1 according to the first embodiment. A mobile communication system 1 complies with a 5th Generation System (5GS) of the 3GPP standards. 5GS will be hereinafter used as an example, but a long term evolution (LTE) system may be applied at least partially to the mobile communication system. A system of the sixth (6G) or subsequent generation system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the Core Network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided to a sensor, a vehicle or an apparatus provided to a vehicle (Vehicle UE), and a flying object or an apparatus provided to a flying object (Aerial UE).

The NG-RAN 10 includes base stations (referred to as “gNBs” in the 5G system) 200. The gNBs 200 are interconnected via an Xn interface that is an inter-base station interface. Each gNB 200 manages one or more cells. The gNB 200 performs wireless communication with the UE 100 that has established connection to the cell of the gNB 200. The gNB 200 has a Radio Resource Management (RRM) function, a function of routing user data (hereinafter simply referred to as “data”), a measurement control function for mobility control and scheduling, and the like. “Cell” is used as a term representing a minimum unit of a wireless communication area. “Cell” is also used as a term representing a function or a resource for performing wireless communication with the UE 100. One cell belongs to one carrier frequency (hereinafter simply referred to as a “frequency”).

Note that the gNB can be also connected to an Evolved Packet Core (EPC) corresponding to a core network of LTE. An LTE base station can be also connected to the 5GC. The LTE base station and the gNB can be also connected via an inter-base station interface.

The 5GC 20 includes an access and mobility management function (AMF) and a user plane function (UPF) 300. The AMF performs various types of mobility control and the like on the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20.

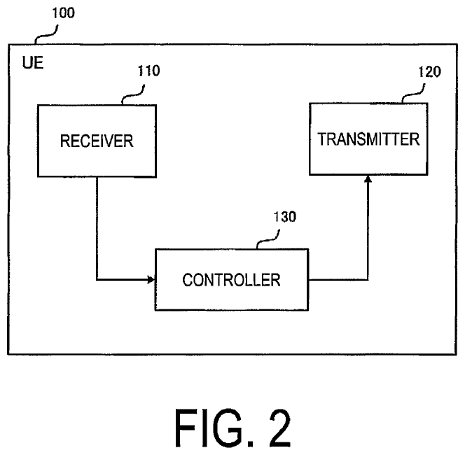

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various types of reception under control of the controller 130. The receiver 110 includes an antenna and a reception device. The receiver converts a radio signal received through the antenna into a baseband signal (reception signal) and outputs the baseband signal to the controller 130.

The transmitter 120 performs various types of transmission under control of the controller 130. The transmitter 120 includes an antenna and a transmission device. The transmitter converts a baseband signal (transmission signal) output by the controller 130 into a radio signal and transmits the radio signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

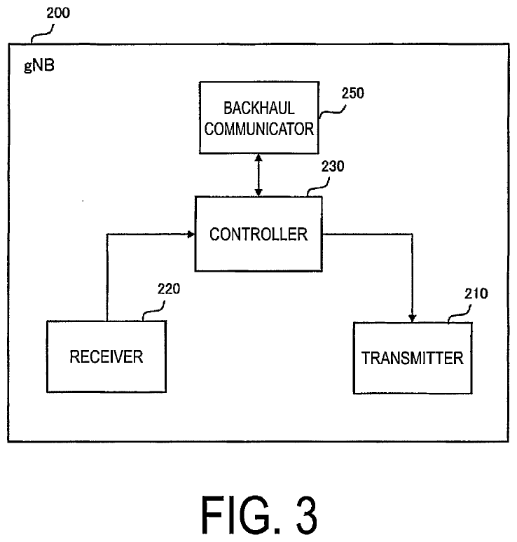

FIG. 3 is a diagram illustrating an example of a configuration of the gNB 200 (base station) according to the first embodiment.

The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various types of transmission under control of the controller 230. The transmitter 210 includes an antenna and a transmission device. The transmitter converts a baseband signal (transmission signal) output by the controller 230 into a radio signal and transmits the radio signal through the antenna.

The receiver 220 performs various types of reception under control of the controller 230. The receiver 220 includes an antenna and a reception device. The receiver converts a radio signal received through the antenna into a baseband signal (reception signal) and outputs the baseband signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

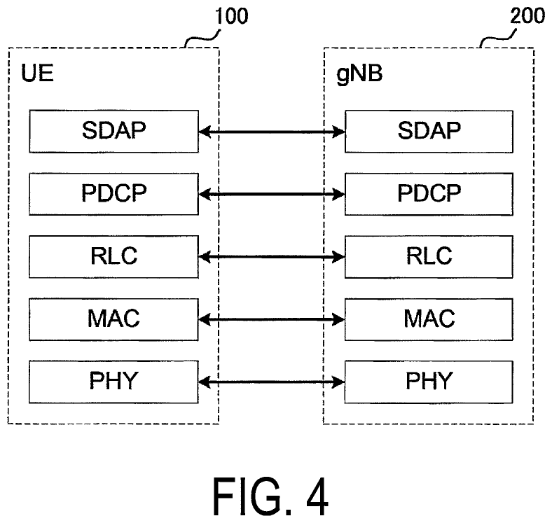

FIG. 4 is a diagram illustrating an example of a configuration of a protocol stack of a user plane radio interface that handles data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives Downlink Control Information (DCI) transmitted from the gNB 200 over a Physical Downlink Control CHannel (PDCCH). More specifically, the UE 100 blind decodes the PDCCH using a Radio Network Temporary Identifier (RNTI) and acquires successfully decoded DCI as DCI addressed to the UE 100. A cyclic redundancy code (CRC) parity bit scrambled by the RNTI is added to the DCI transmitted from the gNB 200.

In NR, the UE 100 can use a bandwidth narrower than a system bandwidth (that is, a cell bandwidth). The gNB 200 configures a bandwidth part (BWP) consisting of consecutive physical resource blocks (PRBs) for the UE 100. The UE 100 transmits and receives data and control signals in an active BWP. For example, up to four BWPs may be configurable for the UE 100. Each BWP may have a different subcarrier spacing. In Each BWP, frequencies may overlap each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs data priority control, retransmission processing using hybrid automatic repeat reQuest (HARQ), random access procedures, or the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the receiving side using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for QoS (Quality of Service) control by the core network, and radio bearers, which are units for QoS control by the access stratum (AS). When the RAN is connected to the EPC, SDAP may not be required.

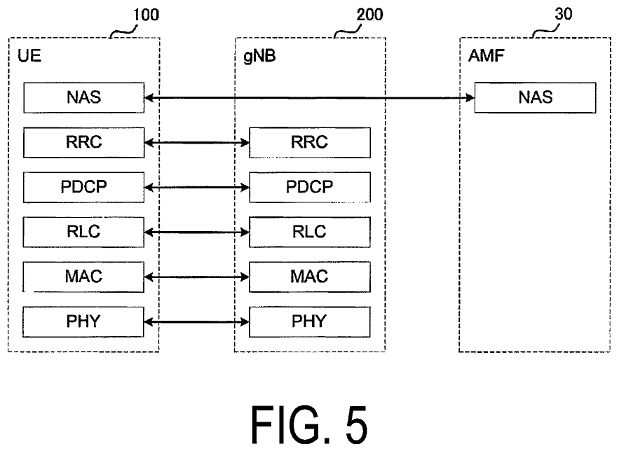

FIG. 5 illustrates a configuration of a protocol stack of a radio interface of a control plane that handles signaling (control signals).

The protocol stack of the radio interface of the control plane includes a radio resource control (RRC) layer and a non-access stratum (NAS) instead of the SDAP layer illustrated in FIG. 4.

RRC signaling for various settings is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as an Access Stratum (AS).

### (AI/ML Technology)

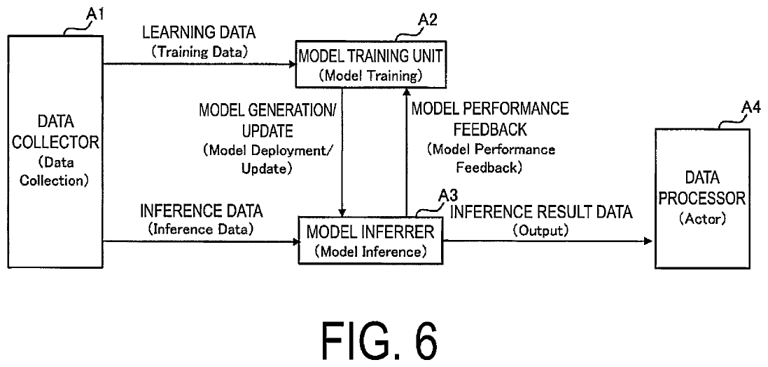

In the embodiment, an AI/ML Technology will be described. FIG. 6 is a diagram illustrating a configuration example of functional blocks of the AI/ML technology in the mobile communication system 1 according to the first embodiment.

The functional block configuration example illustrated in FIG. 6 includes a data collector A1, a model training unit A2, a model inferrer A3, and a data processor A4.

The data collector A1 collects input data, specifically, training data and inference data. The data collector A1 outputs the training data to the model training unit A2. The data collector A1 also outputs the inference data to the model inferrer A3. The data collector A1 may acquire data in the device in which the data collector A1 is provided, as input data. The data collector A1 may acquire, as the input data, data in another apparatus.

The model training unit A2 performs model training. Specifically, the model training unit A2 optimizes parameters of the training model through machine learning using the training data, and derives (or generates (deploys), or updates) the trained model. The model training unit A2 outputs the derived trained model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. The supervised learning is a method of using correct answer data for the training data. The unsupervised learning is a method of not using correct answer data for the training data. For example, in the unsupervised learning, feature points are learned from a large amount of training data, and correct answer determination (range estimation) is performed. The reinforcement learning is a method of assigning a score to an output result and learning a method of maximizing the score. Although supervised learning will be described below, unsupervised learning or reinforcement learning may be applied as machine learning.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. The model has various approaches, such as linear regression analysis, neural network, and decision tree analysis. The above “y=ax+b” can be considered as a kind of the linear regression analysis. The model inferrer A3 may perform model performance feedback to the model training unit A2.

The data processor A4 receives the inference result data and performs processing that utilizes the inference result data.

### Communication Method According to First Embodiment

When a learner performs machine learning, in cases, the learner uses training data from an environment other than his/her own environment. This allows the learner to eliminate insufficient learning and create a trained model from a large amount of training data.

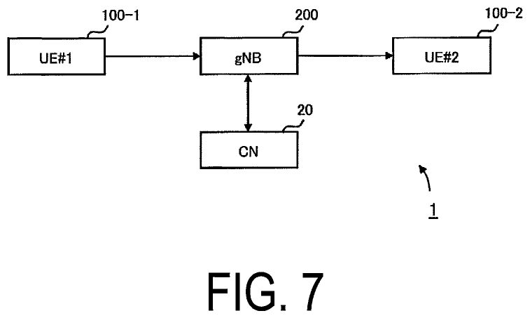

FIG. 7 is a diagram illustrating an example of a configuration of the mobile communication system 1 according to the first embodiment. The example illustrated in FIG. 7 indicates an example in which the training data and/or the inference data used in performing machine learning in the UE 100-1 (hereinafter, “training data and/or inference data” may be referred to as “the learning inference data”) is transmitted to UE 100-2 via the gNB 200. In this case, the UE 100-2 can create a learning model using the learning data used in the UE 100-1 and obtain an inference result using the inference data used in the UE 100-1.

In such a case, for example, the following case is assumed. That is, the UE 100-1 transmits “input: its own terminal model name, DL-TDOA (Downlink Time Difference Of Arrival), RSRP” and “output: position information” as the learning inference data to the UE 100-2 via the gNB 200. DL-TDOA represents a scheme for calculating the position information of the UE 100-1 calculated from an arrival time difference at the UE 100-1 of a signal transmitted from the gNB 200. Reference signal received power (RSRP) represents the received power of a reference signal transmitted from the gNB 200.

In such a case, the UE 100-2 acquires the “terminal model name” and current “position information” of the UE 100-1. That is, the UE 100-2 can ascertain where a terminal model name of the UE 100-1 is currently located. Therefore, security or privacy may become an issue for the UE 100-1.

In the first embodiment, a purpose is to ensure security or privacy in machine learning in a mobile communication system.

Therefore, in the first embodiment, first, the first user equipment (for example, the UE 100-1) transmits the training data and/or the inference data to a network apparatus (for example, the gNB 200 or the CN 20). Second, the network apparatus deletes the security target data and/or the privacy target data from the training data and/or the inference data. Second, the network apparatus transmits the training data after deletion and/or the inference data after deletion to the second user equipment (for example, the UE 100-2). Third, the second user equipment performs machine learning using the training data after deletion and/or the inference data after deletion.

Thus, in the first embodiment, the gNB 200 or the CN 20 deletes the security target data and/or the privacy target data (hereinafter, “the security target data and/or the privacy target data” may be referred to as “target data”) from the learning inference data used in the UE 100-1. Accordingly, the learning inference data of the UE 100-1 is transmitted to the UE 100-2 in a state where the target data has been deleted. Therefore, the UE 100-2 does not receive the target data related to the security or privacy of the UE 100-1. Therefore, in the first embodiment, security or privacy can be ensured.

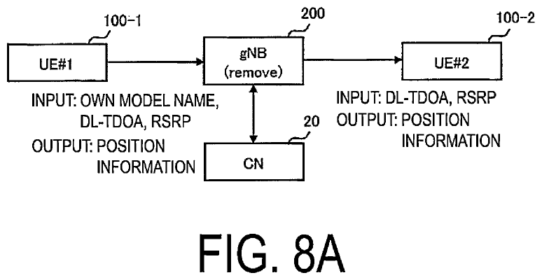

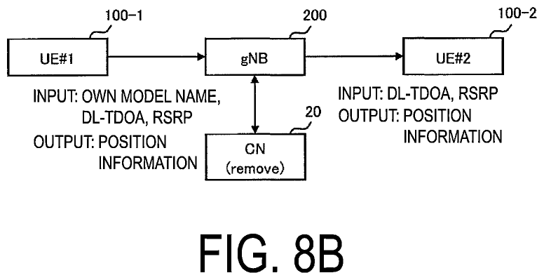

FIGS. 8A and 8B are diagrams illustrating an example in which the learning inference data is deleted according to the first embodiment. As illustrated in FIG. 8A, the gNB 200 may perform deletion of the target data. As illustrated in FIG. 8B, the CN 20 may delete the target data. In FIGS. 8A and 8B, “input: own terminal model name, DL-TDOA (Downlink Time Difference Of Arrival), RSRP” and “output: position information” are examples of the learning inference data. Among these, an example in which “own terminal model name” has been deleted as the target data is shown.

### (Configuration Example of the UE 100 and gNB 200)

A configuration example of the UE 100 and gNB 200 will be described.

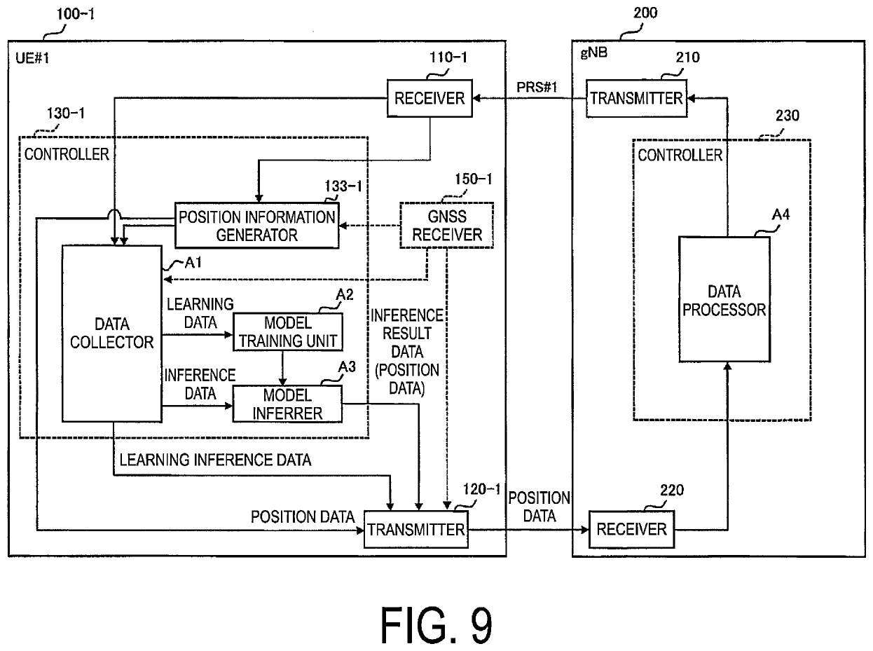

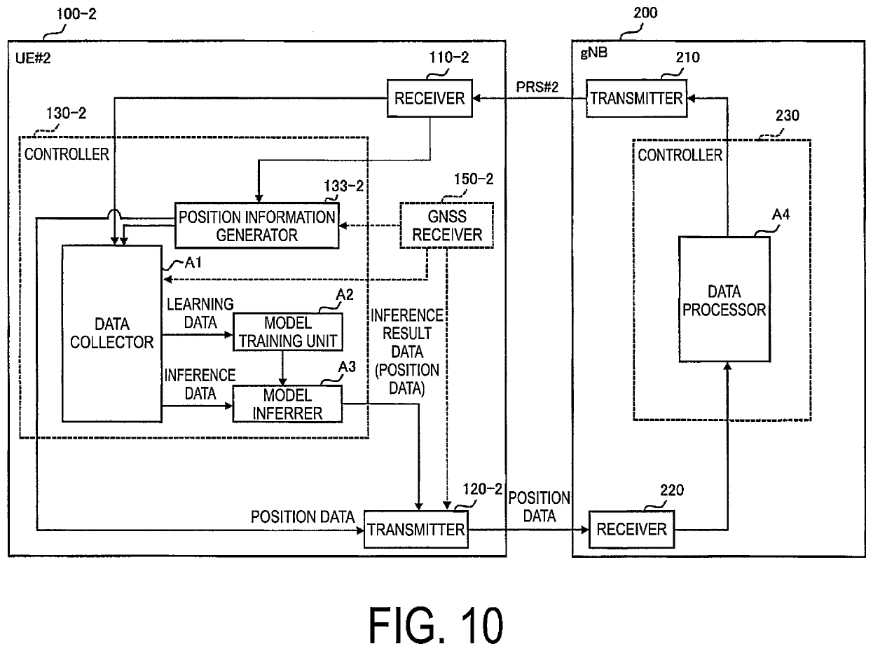

FIG. 9 illustrates a configuration example of the UE 100-1 and gNB 200 according to the first embodiment, and FIG. 10 illustrates a configuration example of the UE 100-2 and gNB 200 according to the first embodiment.

The configuration examples illustrated in FIG. 9 and FIG. 10 are configuration examples in which a “positioning accuracy enhancement” scenario is used as an artificial intelligence machine learning (AIML) operation scenario. The “positioning accuracy enhancement” scenario is an operation scenario in which the accuracy of the position information measured by the UEs 100-1 and 100-2 is enhanced using the machine learning technology. In the “positioning accuracy enhancement” scenario illustrated in FIGS. 9 and 10, for example, “input: positioning reference signal (PRS)” and “output: position data” are used as the learning inference data.

As illustrated in FIG. 9, the UE 100-1 includes a receiver 110-1, a transmitter 120-1, and a controller 130-1. The controller 130-1 includes a position information generator 133-1, a data collector A1, a model training unit A2, and a model inferrer A3. As illustrated in FIG. 9, the gNB 200 includes a transmitter 210, a receiver 220, and a controller 230. The controller 230 includes a data processor A4.

The data collector A1 collects the PRS received by the receiver 110 (the PRS received by the UE 100-1 may be referred to as PRS #1) and the position data generated by the position information generator 133-1. The model training unit A2 generates a trained model from the training data (PRS #1 and position data), and the model inferrer A3 uses the trained model to obtain inference result data (position data) from the inference data (PRS #1 and position data).

Thus, in the UE 100-1, “input: PRS” and “output: position data” are used as the learning inference data. The transmitter 120-1 transmits the learning inference data output from the data collector A1 to the gNB 200. In the gNB 200, the learning inference data received by the receiver 220 is output to the transmitter 210 via the data processor A4.

The position information generator 133-1 generates the position data of the UE 100-1 based on the PRS #1 received by the receiver 110-1. A positioning scheme may be the DL-TDOA scheme described above. The positioning scheme may be a multi-RTT (roundtrip time) scheme or a DL-AoD (downlink angle-of-departure) scheme. The multi-RTT scheme is a positioning scheme for measuring a round trip time (round trip time) from a time difference between transmission and reception in each cell, and calculating distances (at least three distances) from the round trip time to measure a position of the UE 100-1. The DL-AoD scheme is a positioning scheme for calculating an angle of departure (AoD) of PRS #1 from the received power of PRS #1 and acquiring the position data of the UE 100-1 from intersection position in three directions.

The position information generator 133-1 may generate the position data based on a GNSS reception signal received by the global navigation satellite system (GNSS) receiver 150-1. In this case, the model training unit A2 generates a trained model using the training data (the GNSS reception signal and the position data). The model inferrer A3 uses the trained model to obtain inference result data (position data) from the inference data (the GNSS reception signal and the position data). In this case, the learning inference data is “input: GNSS signal” and “output: position data”.

In the “positioning accuracy enhancement” scenario, the “input” that is a target of the learning inference data may be at least one of the following, in addition to the “PRS” and the “GNSS reception signal”.
((X1) Reference signal received power (RSRP), reference signal received quality (RSRQ), signal-to-interference-plus-noise ratio (SINR), and an output waveform of an AD converter (a measurement target thereof may be PRS. The measurement target may be other received signals received from the gNB 200).
(X2) Line of sight (LOS) or non line of sight (NLOS)
(X3) Measurement timing, accuracy, likelihood
(X4) RF fingerprint
(X5) Angle of arrival (AOA) of a received signal, a reception level for each antenna, a reception phase for each antenna, and an observed time difference of arrival (OTDOA) for each antenna
(X6) Reception information of a beacon used in short-range wireless communication such as wireless local area network (LAN) such as Wi-Fi (registered trademark), or Bluetooth (registered trademark)
(X7) A moving speed of the UE 100 (the moving speed may be measured by the GNSS receiver 150-1 or 150-2. The moving speed may be measured by a speed sensor in the UE 100).

In the gNB 200, the receiver 220 receives the learning inference data transmitted from the UE 100-1 and transmits the learning inference data to the controller 230. The controller 230 (or the data processor A4) confirms whether the learning inference data includes target data, and deletes the target data when the target data is included. The controller 230 (or the data processor A4) outputs the learning inference data after deletion to the transmitter 210.

As illustrated in FIG. 10, the UE 100-2 includes a receiver 110-2, a transmitter 120-2, and a controller 130-2. The controller 130-2 includes a position information generator 133-2, a data collector A1, a model training unit A2, and a model inferrer A3.

The transmitter 210 of the gNB 200 transmits the learning inference data after deleting the target data to the UE 100-2.

The receiver 110-2 of the UE 100-2 receives the PRS transmitted from the gNB 200 (the PRS received by the UE 100-2 may be referred to as PRS #2) and the learning inference data after deletion transmitted from the gNB 200. The data collector A1 outputs the PRS received by the receiver 110-2 and the position data generated by the position information generator 133-2 to the model training unit A2 as the training data and to the model inferrer A3 as the inference data. In this case, the data collector A1 outputs the training data of the learning inference data after deletion received by the receiver 110-2 to the model training unit A2, and outputs the inference data to the model inferrer A3. That is, the model training unit A2 generates the trained model using the training data (PRS #2 and position data) acquired by itself and the training data not including the target data (PRS #1 and position data) used by the UE 100-1. The model inferrer A3 also obtains an inference result (position data) using the inference data (PRS #2 and position data) acquired by itself and the inference data not including the target data (PRS #1 and position data) used by the UE 100-1.

The UE 100-2 may also acquire the position data using the GNSS receiver 150-2. When the position data is acquired by using the GNSS receiver 150-2, the learning inference data may be the “GNSS reception signal” instead of “PRS #2”.

### Example of Operation According to First Embodiment

An example of an operation according to the first embodiment will be described.

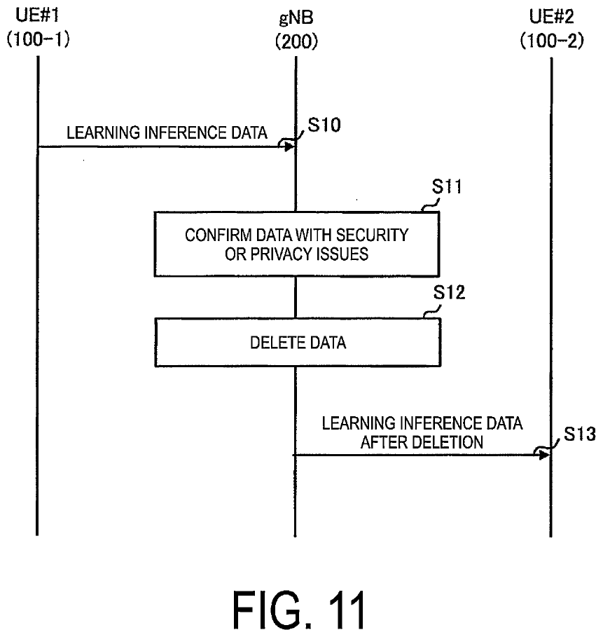

FIG. 11 illustrates an example of an operation according to the first embodiment. FIG. 11 shows an operation example when the gNB 200 is used as an example of a network apparatus.

As illustrated in FIG. 11, in step S10, the UE 100-1 transmits the learning inference data to the gNB 200. The UE 100-1 may transmit the learning inference data to the gNB 200 using the RRC message. The gNB 200 may request the UE 100-1 to transmit the learning inference data. The gNB 200 may make the request by transmitting an RRC message (or MAC CE (Control Element), or DCI (Downlink Control Information)) including information indicating a request to transmit the learning inference data. The UE 100 may transmit the learning inference data in response to receiving the request.

In step S11, the gNB 200 confirms whether the learning inference data includes data that is problematic in terms of security or privacy (that is, target data). The target data may be designated by the UE 100-1 or UE 100-2. The target data may be hard-coded in a specification. When the UE 100-1 or UE 100-2 designates the target data, the UE 100-1 or UE 100-2 may transmit an RRC message (or MAC CE, or DCI) including information indicating the target data to the gNB 200, so that the designation is performed. When the machine learning is performed in the gNB 200, the target data is not visible to general users, and therefore, the machine learning may be performed including the target data.

In step S12, the gNB 200 deletes the target data from the learning inference data. For example, in the above-described example, the gNB 200 deletes the “terminal model name” (target data) from “input: own terminal model name, DL-TDOA, RSRP” and “output: position information” (the learning inference data). The UE 100-2 may designate the target data that is a deletion target. The UE 100-2 may perform the designation by transmitting an RRC message (or MAC CE or DCI) including information indicating the target data from the gNB 200. The gNB 200 deletes the designated target data from the learning inference data.

In step S13, the gNB 200 transmits the learning inference data after deletion to the UE 100-2. The gNB 200 may transmit the learning inference data after deletion to the UE 100-2 using the RRC message. The UE 100-2 performs machine learning using the learning inference data after deletion.

### Other Example 1 of First Embodiment

In the first embodiment, the gNB 200 has been described as an example of the network apparatus, but the present disclosure is not limited thereto. The network apparatus may be a core network apparatus (CN) 20. The CN 20 may be an AMF. The CN 20 may be a UPF. The CN 20 may be another core network apparatus.

For an operation example when the network apparatus is the CN 20, FIG. 11 is also used. In this case, the gNB 200 may be replaced with the CN 20 in FIG. 11. A NAS message may be used instead of an RRC message between the UE 100-1 and the gNB 200. In the same or similar manner, a NAS message may be used instead of an RRC message between the gNB 200 and the UE 100-2.

### Other Example 2 of First Embodiment

In the first embodiment, an example in which a “positioning accuracy enhancement” scenario is used as an operation scenario has been described, but the present disclosure is not limited thereto. For example, “channel state information (CSI) feedback enhancement” may be used as the operation scenario.

The “CSI feedback enhancement” scenario represents an operation scenario when the machine learning technology is applied to the CSI feedback fed back from the UE 100 to the gNB 200. The learning inference data in the “CSI feedback enhancement” scenario is, for example, “input: CSI-RS” and “output: CSI”.

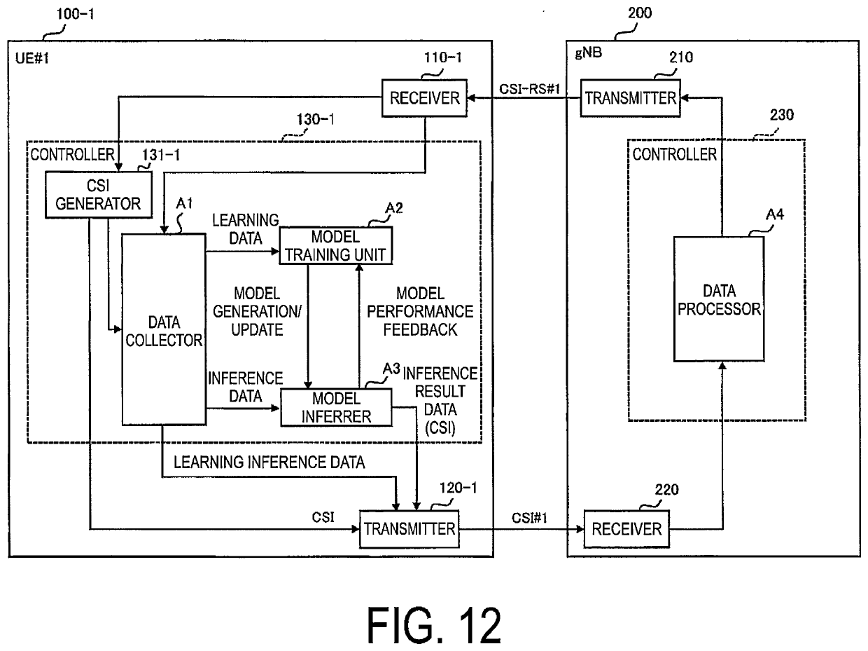

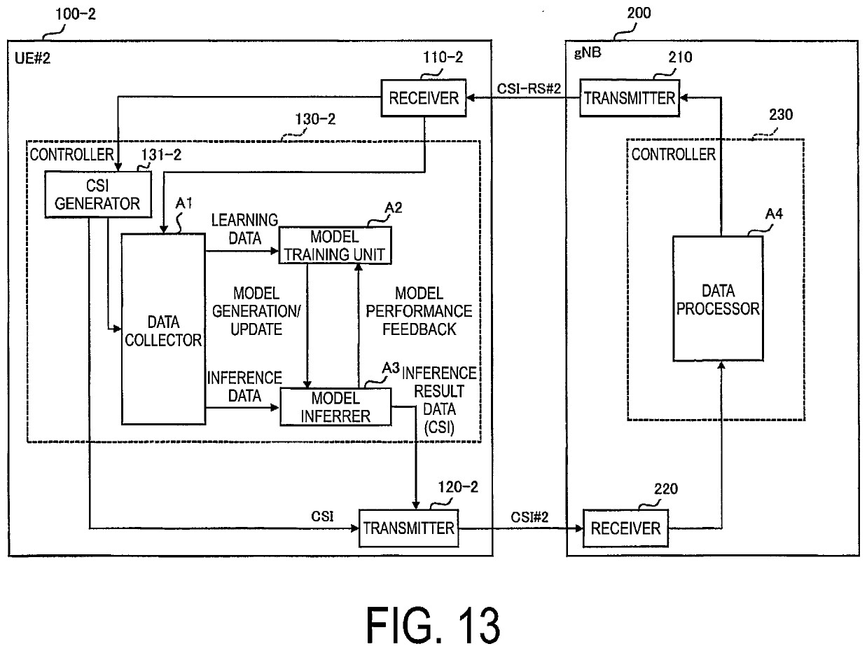

FIG. 12 illustrates an example of a configuration of the UE 100-1 and the gNB 200 when the “CSI feedback enhancement” scenario is applied, and FIG. 13 illustrates an example of a configuration of the UE 100-2 and the gNB 200 when the “CSI feedback enhancement” scenario is applied.

As illustrated in FIG. 12, in the “CSI feedback enhancement” scenario, the CSI reference signal (CSI-RS) received from the gNB 200 (the CSI-RS received by the UE 100-1 may be referred to as “CSI-RS #1”) and the CSI generated from the CSI-RS #1 by the CSI generator 131-1 are used as the training data. The model training unit A2 uses the training data (CSI-RS #1 and CSI) to generate the trained model. The model inferrer A3 uses the trained model to obtain inference result data (CSI) from the inference data (CSI-RS #1 and CSI). The transmitter 120-1 transmits the learning inference data to the gNB 200. In this case, the learning inference data is “input: CSI-RS” and “output: CSI”. In the gNB 200, the target data is deleted from the learning inference data, as the same as or similar to the first embodiment.

The CSI includes at least one selected from the group constituting of a channel quality indicator (CQI), a precoding matrix indicator (PMI), and a rank indicator (RI). The gNB 200 performs downlink scheduling and the like based on the CSI.

As illustrated in FIG. 13, the transmitter 210 of the gNB 200 transmits the learning inference data (CSI-RS #1 and CSI) received from the UE 100-1 to the UE 100-2. The model training unit A2 of the UE 100-2 generates the trained model using the training data (CSI-RS #2 and CSI) acquired by itself and the training data (CSI-RS #1 and CSI) after the target data deletion used by the UE 100-1. The model inferrer A3 obtains an inference result (CSI) using the inference data (CSI-RS #2 and CSI) acquired by itself and the inference data (CSI-RS #1 and CSI) after target data deletion used by the UE 100-1.

An operation example in the “CSI feedback enhancement” scenario is also illustrated in FIG. 11. In this case, the same processing may be performed, except that the target of the learning inference data is different from that in the “positioning accuracy enhancement” scenario.

In the “CSI feedback enhancement” scenario, the data used for “input” of the learning inference data may be any of the following data other than the CSI-RS.
(Y1) RSRP, RSRQ, SINR, or an output waveform of AD converter (a measurement target thereof may be CSI-RS. The measurement target may be other received signals received from the gNB 200)
(Y2) Bit error rate (BER) or block error rate (BLER) (BER (or BLER) may be measured based on CSI-RS with a total number of transmission bits (or a total number of transmission blocks) being known)
(Y3) Moving speed of the UE 100 (the moving speed may be measured by the GNSS receiver 150-1 or 150-2 in the UE 100. The moving speed may be measured by a speed sensor in the UE 100)

### Other Example 3 According to First Embodiment

In the first embodiment, a “Beam management” scenario may be applied as the operation scenario. The “beam management” scenario is, for example, an operation scenario in which the machine learning technology is used to manage which beam is an optimal beam among the beams transmitted from the gNB 200. The learning inference data in the “beam management” scenario is, for example, “Input: CSI-RS” and “Output: (Information representing) optimal beam”.

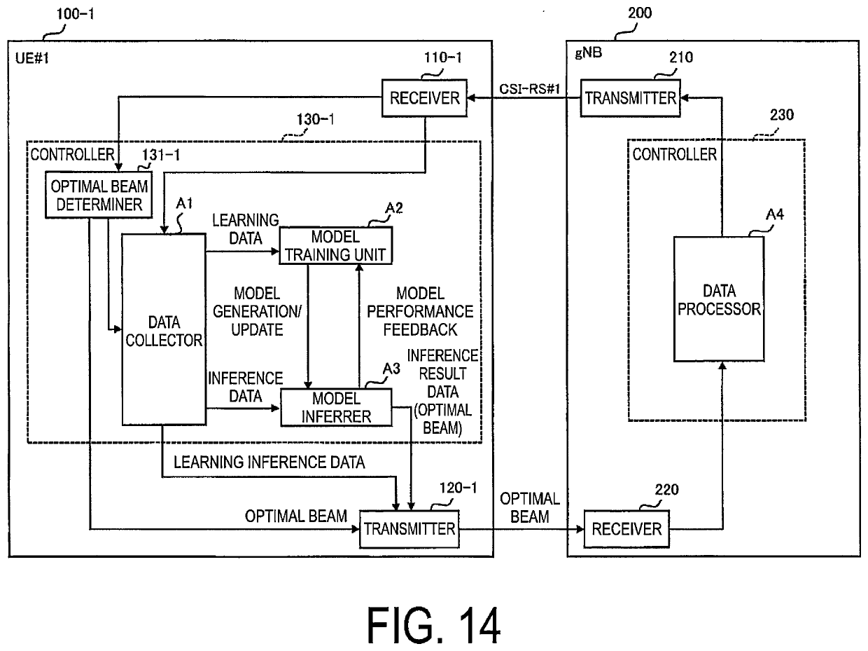

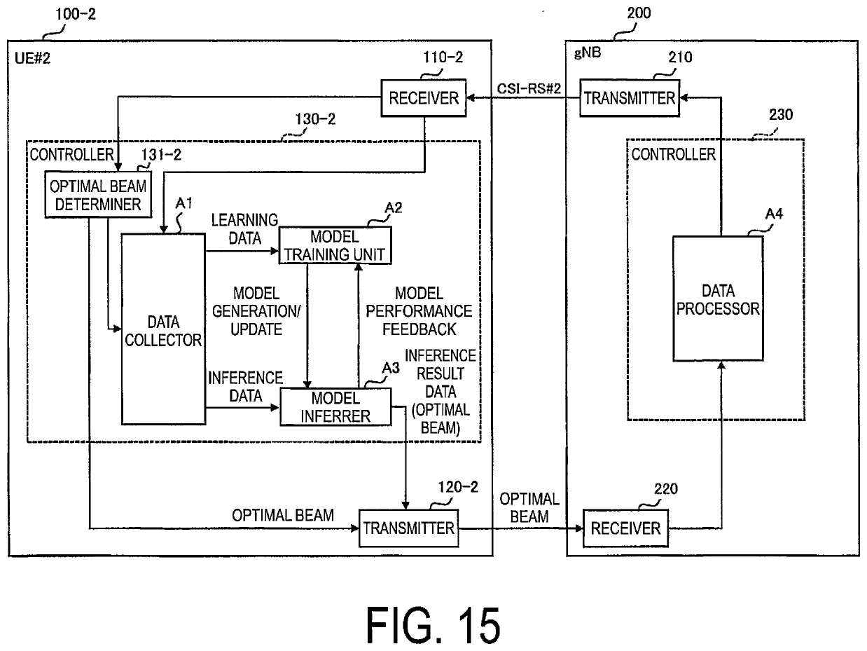

FIG. 14 illustrates an example of a configuration of the UE 100-1 and the gNB 200 when the “beam management” scenario is applied. FIG. 15 illustrates an example of a configuration of the UE 100-2 and the gNB 200 when the “beam management” scenario is applied.

As illustrated in FIG. 14, in the UE 100-1, the CSI-RS received from the gNB 200 and the optimal beam determined from the CSI-RS in the optimal beam determiner 132-1 are used as the training data. In the model training unit A2, a trained model is generated using the training data (CSI-RS #1 and optimal beam). In the model inferrer A3, an inference result (optimal beam) is obtained from the inference data (CSI-RS #1 and optimal beam) using the trained model. The transmitter 120 transmits the learning inference data to the gNB 200. The learning inference data is “input: CSI-RS” and “output: optimal beam”. In the gNB 200, the target data is deleted from the learning inference data, as the same as or similar to the first embodiment.

As illustrated in FIG. 15, the transmitter 210 of the gNB 200 transmits the learning inference data (CSI-RS #1 and optimal beam) received from the UE 100-1 to the UE 100-2. The model training unit A2 of the UE 100-2 generates a trained model using the training data (CSI-RS #2 and optimal beam) acquired by itself and the training data (CSI-RS #1 and optimal beam) used by the UE 100-1 after the target data is deleted. The model inferrer A3 obtains an inference result (optimal beam) using the inference data (CSI-RS #2 and optimal beam) acquired by itself and the inference data after target data deletion used by the UE 100-1 (CSI-RS #1 and optimal beam).

In the operation example in the “beam management” scenario, FIG. 11 is also used. In this case, the same processing may be performed, except that the target of the learning inference data is different from that in the “positioning accuracy enhancement” scenario.

In the “beam management” scenario, for data used for “input” of the learning inference data, any of the following data other than “CSI-RS” may be used.
(Z1) Synchronization signal block (SSB) received from the gNB 200
(Z2) RSRP, RSRQ, SINR, or an AD converter output waveform (a measurement target thereof may be CSI-RS. The measurement target may be other received signals received from the gNB 200)
(Z3) BER or BLER (BER (or BLER) may be measured based on CSI-RS with a total number of transmission bits (or a total number of transmission blocks) known)
(Z4) Number of beams or beam pattern
(Z5) Measurement value of beam (including multiple)
(Z6) Moving speed of the UE 100 (the moving speed may be measured by the GNSS receiver 150-1 or 150-2 in the UE 100. The moving speed may be measured by a speed sensor in the UE 100)

### Second Embodiment

A second embodiment will be described.

In the second embodiment, an example in which the learning inference data is encrypted will be described.

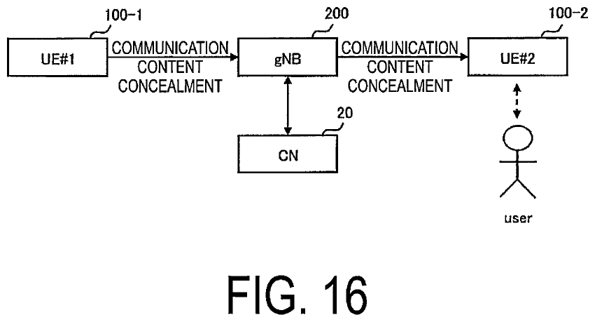

FIG. 16 is a diagram illustrating an example of a configuration of a mobile communication system 1 according to the second embodiment. As illustrated in FIG. 16, communication content is concealed by encrypting the learning inference data. Generally, the encryption keeps data content confidential from anyone other than the user who has received the data.

On the other hand, in the second embodiment, the UE 100-2 decrypts the encrypted learning inference data in the machine learning model. The user using the UE 100-2 cannot ascertain what processing is performed in the machine learning model in principle (or unless the user has a specific authority). Therefore, even when the encrypted learning inference data is decrypted in the machine learning model of the UE 100-2, the confidentiality of the learning inference data content can be maintained. Therefore, in the second embodiment, security or privacy can be ensured in machine learning in the mobile communication system 1.

The machine learning model is, for example, a component part (or a block part) in which machine learning is performed. The machine learning model may be an entire block represented by a functional block diagram illustrated in FIG. 6. For example, in the second embodiment, the learning inference data may be encrypted and/or decrypted in the data collector A1 of the machine learning model. In principle, the user using the UE 100-2 cannot access the data collector A1, and therefore cannot ascertain the content of the decrypted learning inference data (the learning inference data used in the UE 100-1).

In the second embodiment, two encryption schemes including a private key scheme and a common key scheme will be described.

### First Operation Example According to Second Embodiment: Private Key Scheme

The first operation example according to the second embodiment will be described. In the first operation example, an example using a private key scheme as an encryption scheme will be described.

Specifically, first, a network apparatus (for example, the gNB 200 or CN 20) receives training data and/or inference data from the first user equipment (for example, the UE 100-1). Second, the network apparatus requests a public key from the second user equipment (for example, the UE 100-2). Third, the second user equipment transmits a public key created from a private key in the machine learning model to the network apparatus in response to the request. Fourth, the network apparatus encrypts the training data and/or the inference data using the public key, and transmits the encrypted training data and/or the encrypted inference data to the second user equipment. Fifth, the second user equipment decrypts the encrypted training data and/or the encrypted inference data using the private key, and performs machine learning in the machine learning model using the decrypted training data and/or the decrypted inference data. Thus, in the first operation example, the gNB 200 uses the public key to encrypt the learning inference data used in the UE 100-1, so that the confidentiality of the learning inference data between the gNB 200 and the UE 100-2 can be maintained. In the first operation example, the encrypted learning inference data is decrypted in the machine learning model of the UE 100-2, so that it is not easy for the user using the UE 100-2 to ascertain the content of the learning inference data. Therefore, in the first operation example, security or privacy can be ensured in machine learning in the mobile communication system 1.

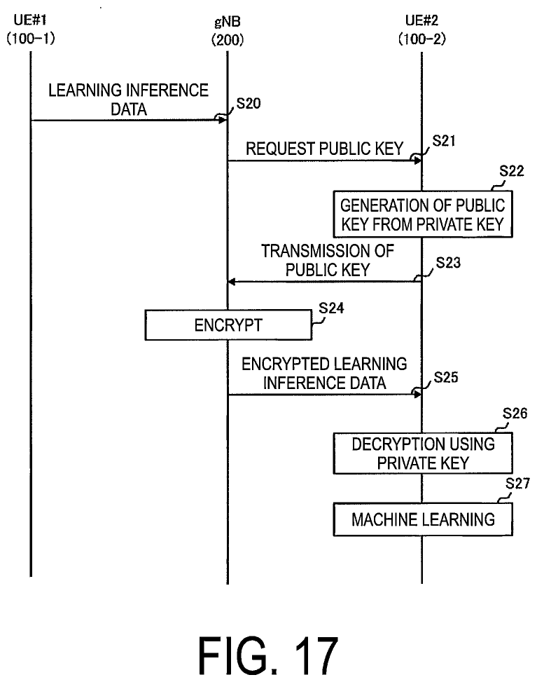

FIG. 17 is a diagram illustrating the first operation example according to the second embodiment.

As illustrated in FIG. 17, in step S20, the UE 100-1 transmits the learning inference data to the gNB 200. The UE 100-1 may transmit the learning inference data using the RRC message or the like. The gNB 200 may request the UE 100-1 to transmit the learning inference data. The request may be made using the RRC message, a MAC CE, a DCI, or the like.

In step S21, the gNB 200 requests the UE 100-2 for a public key. The gNB 200 may make the request to the AS of the UE 100 using the RRC message, the MAC CE, or the DCI. The UE 100-2 may make a request to the gNB 200 to transmit the learning inference data. In this case, the UE 100-2 may designate an encryption scheme (for example, a private key scheme). For the transmission request and the designation, an RRC message, a MAC CE, or a DCI may also be used.

In step S22, the UE 100-2 creates a public key from the private key in the machine learning model in response to the request for the public key. In the UE 100-2, for example, the following process is performed. That is, the AS of the UE 100-2 requests a public key from the data collector A1 of the machine learning model in response to the request. The data collector A1 holds the private key in a memory or the like, and creates a public key from the private key in response to the request. The data collector A1 outputs the created public key to the AS of the UE 100-2 (or the NAS of the UE 100-2). The AS of the UE 100-2 (or the NAS of the UE 100-2) may receive the public key in advance from the machine learning model (that is, the data collector A1).

In step S23, the UE 100-2 transmits the public key to the gNB 200. The AS of the UE 100-2 may transmit the public key using the RRC message or the like.

In step S24, the gNB 200 encrypts the learning inference data using the public key.

In step S25, the gNB 200 transmits the encrypted learning inference data to UE 100-2. The gNB 200 may transmit the encrypted learning inference data using the RRC message or the like.

In step S26, the UE 100-2 decrypts the encrypted learning inference data using the private key. In the UE 100-2, for example, the following process is performed. That is, the AS of the UE 100-2 (or the NAS of the UE 100-2) outputs the encrypted learning inference data received from the gNB to the data collector A1 of the machine learning model. The data collector A1 decrypts the encrypted learning inference data using the private key stored in a memory or the like.

In step S27, the UE 100-2 performs machine learning using the decrypted learning inference data. In the UE 100-2, for example, the following processing is performed. That is, the data collector A1 outputs the decrypted training data to the model training unit A2, and outputs the decrypted inference data to the model inferrer A3. That is, in the machine learning model, machine learning is performed using the decrypted learning inference data.

In the first operation example, each of the above-described operation scenarios (the “positioning accuracy enhancement” scenario, the “CSI feedback enhancement” scenario, or the “beam management” scenario) can be applied. When the “positioning accuracy enhancement” scenario is applied, the learning inference data may be, for example, “input: PRS” and “output: position data”. When the “CSI feedback enhancement” scenario is applied, the learning inference data may be, for example, “input: CSI-RS” and “output: CSI”. When the “beam management” scenario is applied, the learning inference data may be, for example, “input: CSI-RS” and “output: optimal beam”. The learning inference data may be data corresponding to each operation scenario.

### Other Example 1 of First Operation Example

In the first operation example, the example in which the learning inference data is encrypted has been described, but the encryption target may be the entire learning inference data. The encryption target may be a part of the learning inference data. For example, the gNB 200 encrypts data related to privacy among the learning inference data. The encryption target may be determined by the gNB 200.

### Other Example 2 of First Operation Example

In the first operation example, the gNB 200 is used as an example of the network apparatus, but the present disclosure is not limited thereto. The network apparatus may be the CN 20. When the network apparatus is the CN 20, the gNB 200 may be read as the CN 20 in the operation example illustrated in FIG. 17. In this case, a NAS message may be used instead of an RRC message between the UE 100-1 and the CN 20. The process performed in the AS of the UE 100-1 may be read as the process performed in the NAS of the UE 100-1. In the same or similar manner, the NAS message may be used instead of an RRC message between the CN 20 and the UE 100-2. In this case, the process performed in the AS of the UE 100-2 may be read as the process performed in the NAS of the UE 100-2.

### Second Operation Example According to Second Embodiment

The second operation example is an example in which a common key is used as the encryption scheme.

Specifically, first, the first machine learning model of the first user equipment (for example, the UE 100-1) encrypts the training data and/or the inference data using the common key. Second, the first user equipment transmits the encrypted training data and/or the encrypted inference data to a network apparatus (for example, the gNB 200 or CN 20). Third, the network apparatus transmits the encrypted training data and/or the encrypted inference data to the second user equipment (for example, the UE 100-2). Fourth, the second machine learning model of the second user equipment decrypts the encrypted training data and/or the encrypted inference data using the common key, and performs machine learning using the decrypted training data and/or the decrypted inference data.

Thus, in the second operation example, since the UE 100-1 encrypts the learning inference data using the public key, the confidentiality of the learning inference data between the UE 100-1 and the UE 100-2 can be maintained. In the second operation example, since decryption is performed in the machine learning model of the UE 100-2, it is not easy for the user using the UE 100-2 to ascertain the content of the learning inference data, as the same as or similar to the first operation example. Therefore, in the second operation example, it is also possible to ensure the security or privacy.

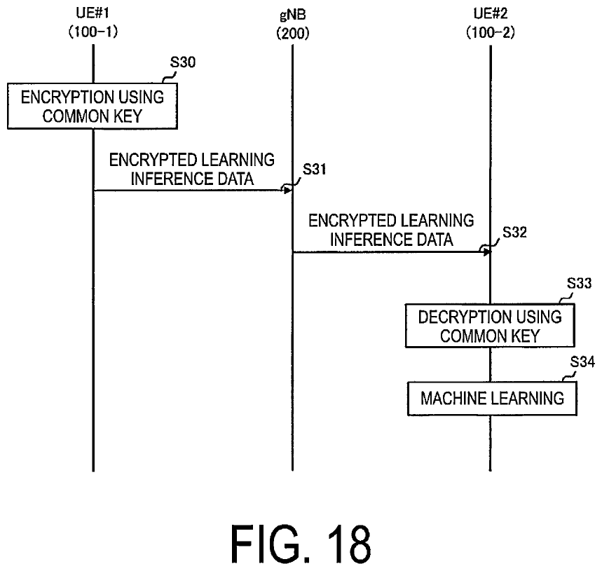

FIG. 18 is a diagram illustrating a second operation example according to the second embodiment.

As illustrated in FIG. 18, in step S30, the UE 100-1 encrypts the learning inference data using the common key. For example, the data collector A1 in the machine learning model of the UE 100-1 encrypts the learning inference data using the common key stored in the memory or the like. The data collector A1 outputs the encrypted learning inference data to the AS of the UE 100-1 (or the NAS of the UE 100-2). The gNB 200 may request the UE 100-1 to transmit the learning inference data, or may designate an encryption scheme (for example, a common key scheme). The request and the designation may be made using the RRC message, the MAC CE, or the DCI.

The common key may be transmitted in advance from the gNB 200 to the data collector A1 of the UE 100-1. Conversely, the data collector A1 may transmit the common key used by itself to the gNB 200. In the latter case, the gNB 200 may transmit the common key to the UE 100-2 (the data collector A1). The common key may be hard-coded, for example, by being stored in advance in the memory of the data collector A1.

In step S31, the UE 100-1 transmits the encrypted learning inference data to the gNB 200. For example, the AS of the UE 100-1 may transmit the learning inference data to the gNB 200 using the RRC message or the like.

In step S32, the gNB 200 transmits the encrypted learning inference data to the UE 100-2. The UE 100-2 may request the gNB 200 to transmit the learning inference data in advance. The UE 100-2 may designate an encryption scheme (for example, a common key scheme) to the gNB 200. The request and the designation may be made using the RRC message, the MAC CE, or the DCI.

In step S33, the UE 100-2 decrypts the encrypted learning inference data using the common key. In the UE 100-2, for example, the following process is performed. That is, the AS of the UE 100-2 outputs the received learning inference data to the data collector A1 in the machine learning model of the UE 100-2. The data collector A1 decrypts the encrypted learning inference data using the common key stored in the memory or the like. The common key may be transmitted from the gNB 200. The common key may be hard-coded, for example by being stored in the memory in advance.

In step S34, the UE 100-2 performs machine learning using the decrypted learning inference data. For example, the data collector A1 outputs the decrypted training data to the model training unit A2, and outputs the decrypted inference data to the model inferrer A3. In the machine learning model of the UE 100-2, machine learning is performed using the learning inference data of the UE 100-1.

In the second operation example, each of the above-described operation scenarios (the “positioning accuracy enhancement” scenario, the “CSI feedback enhancement” scenario, or the “beam management” scenario) can be applied, as the same as or similar to the first operation example. The learning inference data may be data corresponding to each operation scenario.

### Other Example 1 of Second Operation Example

In a second operation example, a target to be encrypted may be all of learning inference data. The target to be encrypted may be a part of the learning inference data. For example, the gNB 200 encrypts data related to privacy among the learning inference data. The target data to be encrypted may be determined by the gNB 200. The gNB 200 may indicate the target data to be encrypted to the UE 100-2.

### Other Example 2 of Second Operation Example

In the second operation example, an example in which encryption is performed by the UE 100-1 has been described, but the present disclosure is not limited thereto. For example, the encryption may be performed by the gNB 200. In this case, the UE 100-1 transmits the learning inference data to the gNB 200 without encryption (step S31), and the gNB 200 encrypts the learning inference data using the common key. The common key may be transmitted in advance from the UE 100-1 or the UE 100-2 to the gNB 200. The common key may be stored in advance in a memory or the like in the gNB 200 (or may be hard-coded).

### Other Example 3 of Second Operation Example

In a second operation example, the network apparatus is not limited to the gNB 200, and may be the CN 20. In this case, the gNB 200 may be read as the CN 20 in the operation example illustrated in FIG. 18. A NAS message may be used instead of the RRC message between the UE 100-1 and the gNB 200 and between the gNB 200 and the UE 100-2. In this case, the process performed in the AS of the UE 100-1 may be read as the process performed in the NAS of the UE 100-1. The process performed in the AS of the UE 100-2 may be read as the process performed in the NAS of the UE 100-2.

### Third Embodiment

Next, a third embodiment will be described.

In the first operation example of the second embodiment, an example in which the public key is transmitted has been described. In the second operation example of the second embodiment, the common key may be transmitted. In the third embodiment, an example in which such key information is not transmitted or received will be described.

When machine learning is performed in the mobile communication system 1, the machine learning can be divided into a part that changes and a part that does not change as the machine learning is performed. For example, a model part of the trained model or a data part such as the training data is the part that changes. On the other hand, for example, a program that executes the machine learning is the part that does not change. In the mobile communication system 1 according to the third embodiment, the common key is created using the part that does not change, that is, the program that executes machine learning, and the common key is used to encrypt and decrypt the learning inference data.

Specifically, first, a network apparatus (for example, the gNB 200 or CN 20) transmits the program for executing machine learning to the first user equipment (for example, the UE 100-1) and the second user equipment (for example, the UE 100-2). Second, the first user equipment encrypts the training data and/or the inference data using the common key created from the program, and transmits the encrypted training data and/or the encrypted inference data to the network apparatus. Third, the network apparatus transmits the encrypted training data and/or the encrypted inference data to the second user equipment. Fourth, the second user equipment decrypts the encrypted training data and/or the encrypted inference data using the common key created from the program, and performs machine learning using the decrypted training data and/or the decrypted inference data.

Thus, in the third embodiment, the UE 100-1 encrypts the learning inference data using the common key created from the program for executing machine learning, and the UE 100-2 decrypts the encrypted learning inference data using the common key created from the program. Therefore, since the learning inference data is encrypted between the UE 100-1 and the UE 100-2, the learning inference data used in the UE 100-1 can be kept confidential.

Since the common key is created in the UE 100-2 from the program used to execute machine learning, the common key is created in the machine learning model, and the user using the UE 100-2 cannot, in principle, ascertain the decrypted learning inference data as the same as or similar to the second embodiment. Therefore, in the third embodiment, it is also possible to ensure the security or privacy, as the same as or similar to the second embodiment.

In the third embodiment, since the transmission and reception of the common key is eliminated, processing is facilitated in the UEs 100-1 and 100-2 and the gNB 200 compared to the case where a common key is transmitted and received, and it is also possible to effectively utilize communication resources.

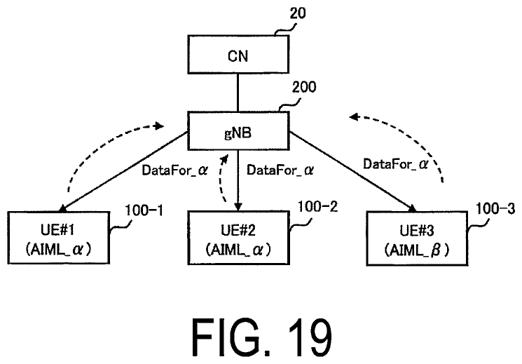

FIG. 19 is a diagram illustrating an example of program transmission according to the third embodiment.

As illustrated in FIG. 19, the gNB 200 transmits a program for executing a machine learning model (for example, AIML_α) to the UEs 100-1 and 100-2. The gNB 200 transmits a program for executing a machine learning model (for example, AIML_β) to the UE 100-3. A case where the gNB 200 creates the common key from a program for executing AIML_α, encrypts the learning inference data using the common key, and transmits (for example, report by broadcast) the encrypted learning inference data is assumed. In such a case, since the UEs 100-1 and 100-2 can create the common key using the same AIML_α as gNB 200, the encrypted learning inference data can be decrypted. However, since the UE 100-3 holds the program for executing AIML_β, it is not possible to decrypt the learning inference data encrypted in the gNB 200 even when the UE 100-3 creates the common key using AIML_β.

Thus, in the third embodiment, the gNB 200 can also transmit the learning inference data by broadcast without considering which machine learning model UEs 100-1 to 100-3 are using. In other words, when the gNB 200 transmits the learning inference data and the learning inference data is matched with the machine learning model of the UE 100, the UE 100 can decrypt the learning inference data transmitted from the gNB 200 and successfully generate the machine learning model. On the other hand, when the learning inference data is not matched with the machine learning model of the UE 100, the UE 100 cannot decode the learning inference data transmitted from the gNB 200 and cannot use the learning inference data. Therefore, the gNB 200 can transmit the learning inference data by broadcast without considering the match with the machine learning models used by the UEs 100-1 to 100-3. The gNB 200 can transmit the learning inference data by broadcast without receiving a notification by signaling from the UEs 100-1 to 100-3 as to which machine learning model is used.

For example, a case where the UE 100-1 transmits the learning inference data used by the UE 100-1 to the UE 100-2 via the gNB 200 is assumed, as the same as or similar to the first embodiment. Even in such a case, for the machine learning to be executed by the UE 100-1 and the UE 100-2, the gNB 200 can transmit the program for executing the machine learning to the UEs 100-1 and 100-2, so that the UEs 100-1 and 100-2 can perform encryption and decryption using the same common key created from the program.

The program for executing the machine learning may be transmitted from each of the UEs 100-1 to 100-3 to the gNB 200. In this case, the machine learning may be performed in the gNB 200.

### Operation Example According to Third Embodiment

An operation example according to the third embodiment will be described.

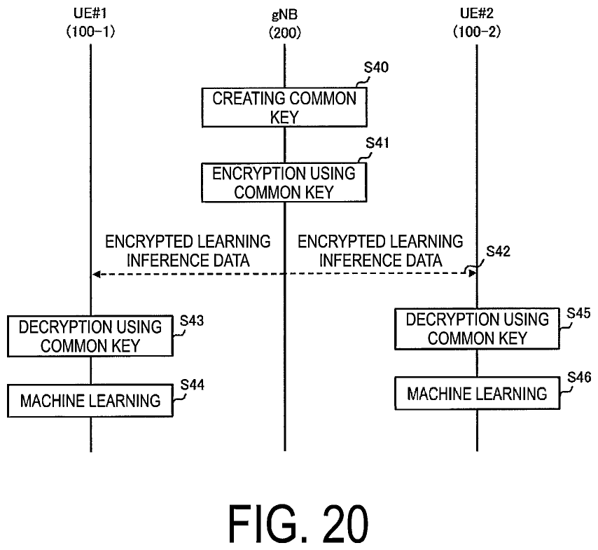

FIG. 20 is a diagram illustrating an operation example according to the third embodiment. The operation example illustrated in FIG. 20 will be described in the example (FIG. 19) in which gNB 200 transmits the program for executing machine learning. Therefore, before the operation example illustrated in FIG. 20 is started, the gNB 200 transmits the same program for executing machine learning (for example, the program for executing AIML_α) to the UE 100-1 and the UE 100-2. For example, the gNB 200 may transmit the program using an RRC message or the like.

In step S40, the gNB 200 creates the common key using the program for executing machine learning transmitted to the UEs 100-1 and 100-2. Any scheme may be used to create the common key. For example, the gNB 200 may receive the program as an input, acquire a hash value using a hash function, and use the hash value as the common key. The hash function may also be any function. The hash function may be, for example, a SHA-2 series such as SHA (Secure Hash Algorithm)-256. The hash function may be a SHA-3 series such as SHA3-256. The hash function may be MD5 (Message Digest 5). For example, the gNB 200 creates the common key from the program for executing AIML_α.

In step S41, the gNB 200 determines to broadcast the learning inference data and encrypts the learning inference data using the common key. For example, the gNB 200 encrypts the learning inference data using the common key created from the program for executing AIML_α.

In step S42, the gNB 200 broadcasts the encrypted learning inference data. The gNB 200 may broadcast the data using an RRC message such as system information (SIB), or may broadcast the data using a paging message. The gNB 200 may broadcast the data using a Multicast and Broadcast Services (MBS) message. The gNB 200 may broadcast the data using a dedicated message of an AIML-dedicated layer. The UE 100-1 and/or UE 100-2 may request the gNB 200 to transmit the learning inference data. The request may be made by an RRC message, MAC CE, DCI, or the like. The gNB 200 may broadcast the encrypted learned inference data in response to the request. The UE 100-1 receives the encrypted learned inference data, and the UE 100-2 also receives the learned inference data.

In step S43, the UE 100-1 creates the common key using the program for executing machine learning received from the gNB 200, and uses the common key to decrypt the encrypted learned inference data. For example, the data collector A1 in the machine learning model of the UE 100-1 creates the common key using the program for executing AIML_α, and uses the created common key to decrypt the encrypted learned inference data. Since the UE 100-1 uses the same common key as the common key used by gNB 200, the UE 100-1 can decrypt the learned inference data encrypted by gNB 200.

In step S44, the UE 100-1 performs machine learning using the decrypted learning inference data.

In step S45, the UE 100-2 also creates the common key using the program for executing machine learning received from the gNB 200, and decrypts the encrypted learning inference data using the common key. For example, the data collector A1 in the machine learning model of the UE 100-2 creates the common key using the program for executing AIML_α, and decrypts the encrypted learning inference data using the created common key. Since the UE 100-2 also uses the same common key as that used by gNB 200, the UE 100-2 can decrypt the learning inference data encrypted by gNB 200.

In step S46, the UE 100-2 also performs machine learning using the decrypted learning inference data.

Steps S43 and S45 may be performed simultaneously. Steps S44 and S46 may also be performed simultaneously. For steps S43 to S46, when machine learning is performed after decoding, the UE 100-1 may perform the process before UE 100-2. The UE 100-2 may perform the process before UE 100-1. The UE 100-1 and UE 100-2 may perform the process at the same time.

Further, in the third embodiment, each of the above-described operation scenarios (the “positioning accuracy enhancement” scenario, the “CSI feedback enhancement” scenario, or the “beam management” scenario) can be applied. The learning inference data is data corresponding to each operation scenario.

### Other Example 1 According to Third Embodiment

In a third embodiment, an example in which the gNB 200 transmits a program for performing machine learning to the UEs 100-1 and 100-2 has been described, but the present disclosure is not limited thereto. For example, the CN 20 may transmit the program to the UEs 100-1 and 100-2. In this case, the CN 20 may transmit the program using a NAS message. The CN 20 may generate a common key from the program, encrypt the learning inference data using the common key, and transmit (or broadcast) the encrypted learning inference data.

### Other Example 2 According to Third Embodiment

In a third embodiment, an example in which the learning inference data is transmitted from the gNB 200 to the UE 100 has been described, but the present disclosure is not limited thereto. For example, a trained model on which the machine learning has been performed in the gNB 200 may be transmitted to the UEs 100-1 and 100-2. In the UE 100-1 and the UE 100-2, machine learning may be further performed using the trained model.

### OTHER EMBODIMENTS

In the first to third embodiments, examples in which the gNB 200 or the CN 20 is used have been described, but the present disclosure is not limited thereto. Instead of the gNB 200 or the CN 20, for example, a dedicated center may be used. For example, in the first embodiment, the dedicated center deletes the target data from the learning inference data received from the UE 100-1, and transmits the learning inference data after deletion to the UE 100-2. For example, in the second embodiment, the dedicated center encrypts the learning inference data received from the UE 100-1 with the public key received from the UE 100-2, and transmits the encrypted learning inference data to the UE 100-2. For example, in the second embodiment, the dedicated center transmits the learning inference data encrypted by the UE 100-1 to the UE 100-2. For example, in the third embodiment, the dedicated center may transmit the program for executing machine learning to the UEs 100-1 and 100-2, encrypt the learning inference data, and transmit (or broadcast) the encrypted learning inference data to the UEs 100-1 and 100-2.

In the first to third embodiments described above, the supervised learning has been mainly described, but the present disclosure is not limited thereto. For example, the first to third embodiments may be applied to unsupervised learning or reinforcement learning.

A program (information processing program) for causing a computer to execute each process or each function according to the above-described embodiment may be provided. A program (e.g., mobile communication program) may be provided that causes the mobile communication system 1 to execute each of the processing operations or each of the functions according to the embodiments described above. The program may be recorded in a computer-readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Such a recording medium may be a memory included in the UE 100 and the gNB 200.

The above-described operation flows are not limited to being performed separately and independently, but two or more operation flows may be performed in combination. For example, some steps of one operation flow may be added to another operation flow or some steps of one operation flow may be replaced with some steps of another operation flow. In each flow, all steps need not be necessarily performed, and only some of the steps may be performed.

In the embodiment and example described above, an example in which the base station is an NR base station (gNB) has been described, but the base station may be an LTE base station (eNB) or a 6G base station. The base station may be a relay node such as an Integrated Access and Backhaul (IAB) node. The base station may be the DU of the IAB node. The UE 100 may be a Mobile Termination (MT) of the IAB node.

The term “network node” mainly means a base station, but may also mean a core network apparatus or a part (CU, DU, or RU) of the base station.

A program that causes a computer to execute each process performed by the UE 100 or the gNB 200 may be provided. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. A circuit that executes each process performed by the UE 100 or the gNB 200 may be integrated, and at least a part of the UE 100 or the gNB 200 may be configured as a semiconductor integrated circuit (chip set or SoC).

As used in this disclosure, the terms “based on” and “depending on” do not mean “based only on” or “depending only on”, unless otherwise specified. The phrase “based on” means both “based only on” and “based at least in part on”. In the same or similar manner, the phrase “depending on” means both “only depending on” and “at least partially depending on”. The terms “include” and “comprise” do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Although the embodiments have been described in detail with reference to the drawings, a specific configuration is not limited to the above-described one, and various design changes, and the like can be made without departing from the gist. It is also possible to combine each embodiment, each operation example, each process, and the like without contradicting.

### Supplements

### Supplement 1

A communication method in a mobile communication system, including the steps of:
transmitting, by a first user equipment, training data and/or inference data to a network apparatus,
deleting, by the network apparatus, security target data and/or privacy target data from the training data and/or the inference data,
transmitting, by the network apparatus, the training data after deletion and/or the inference data after deletion to a second user equipment, and
performing, by the second user equipment, machine learning using the training data after deletion and/or the inference data after deletion.

### Supplement 2

The communication method according to supplement 1, further including the step of:
designating, by the first user equipment or the second user equipment, the security target data as a deletion target and/or the privacy target data as a deletion target.

### Supplement 3

A communication method in a mobile communication system, including the steps of:
receiving, by a network apparatus, training data and/or inference data from a first user equipment,
requesting, by the network apparatus, a public key from the second user equipment,
transmitting, by the second user equipment, the public key created from a private key in a machine learning model to the network apparatus in response to the request,
encrypting, by the network apparatus, the training data and/or the inference data using the public key and transmitting the encrypted training data and/or the encrypted inference data to the second user equipment, and
decrypting, by the machine learning model of the second user equipment, the encrypted training data and/or the encrypted inference data using the private key and performing machine learning using the decrypted training data and/or the decrypted inference data.

### Supplement 4

The communication method according to supplement 3, wherein the step of transmitting the public key includes a step of generating, by a data collector of the machine learning model, the public key from the private key.

### Supplement 5

A communication method in a mobile communication system, including the steps of:
encrypting, by a first machine learning model of a first user equipment, training data and/or inference data using a common key,
transmitting, by the first user equipment, the encrypted training data and/or the encrypted inference data to a network apparatus,
transmitting, by the network apparatus, the encrypted training data and/or the encrypted inference data to a second user equipment, and
decrypting, by a second machine learning model of the second user equipment, the encrypted training data and/or the encrypted inference data using the common key, and performing machine learning using the decrypted training data and/or the decrypted inference data.

### Supplement 6

The communication method according to supplement 5, wherein the step of encrypting includes a step of encrypting, by a data collector of the first machine learning model, the training data and the inference data using the common key, and
the step of decrypting includes a step of decrypting, by a data collector of the second machine learning model, the encrypted training data and/or the encrypted inference data using the common key.

### Supplement 7

A communication method in a mobile communication system, including the steps of:
transmitting, by a network apparatus, a program for executing machine learning to a first user equipment and a second user equipment,
encrypting, by the first user equipment, training data and/or inference data using a common key created from the program, and transmitting the encrypted training data and/or the encrypted inference data to the network apparatus,
transmitting, by the network apparatus, the encrypted training data and/or the encrypted inference data to the second user equipment, and
decrypting, by the second user equipment, the encrypted training data and/or the encrypted inference data using the common key created from the program, and performing machine learning using the decrypted training data and/or the decrypted inference data.

### Supplement 8

The communication method according to any one of supplements 1 to 7, wherein the network apparatus is a base station or a core network apparatus.

### REFERENCE SIGNS

1: Mobile communication system
20: CN
100 (100-1, 100-2, 100-3): UE
110 (110-1, 110-2): Receiver
120 (120-1, 120-2): Transmitter
130 (130-1, 130-2): Controller
131-1, 131-2: CSI generator
132-1, 132-2: Optimal beam determiner
133-1, 133-2: Position information generator
150-1, 150-2: GNSS receiver
200: gNB
210: Transmitter
220: Receiver
230: Controller
A1: Data collector
A2: Model training unit
A3: Model inferrer
A4: Data processor

1. A communication method in a mobile communication system, comprising the steps of:
transmitting, by a first user equipment, training data and/or inference data to a network node;
deleting, by the network node, security target data and/or privacy target data from the training data and/or the inference data;
transmitting, by the network node, the training data after deletion and/or the inference data after deletion to a second user equipment; and
performing, by the second user equipment, machine learning using the training data after deletion and/or the inference data after deletion.

2. The communication method according to claim 1, further comprising the step of:
designating, by the first user equipment or the second user equipment, the security target data as a deletion target and/or the privacy target data as a deletion target.

3. A communication method in a mobile communication system, comprising the step of:
receiving, by a network node, training data and/or inference data from a first user equipment;
requesting, by the network node, a public key from the second user equipment;
transmitting, by the second user equipment, the public key created from a private key in a machine learning model to the network node in response to the requesting;
encrypting, by the network node, the training data and/or the inference data using the public key and transmitting the encrypted training data and/or the encrypted inference data to the second user equipment; and
decrypting, by the machine learning model of the second user equipment, the encrypted training data and/or the encrypted inference data using the private key and performing machine learning using the decrypted training data and/or the decrypted inference data.

4. The communication method according to claim 3, wherein
the transmitting the public key includes generating, by a data collector of the machine learning model, the public key from the private key.

5. A communication method in a mobile communication system, comprising the steps of:
encrypting, by a first machine learning model of a first user equipment, training data and/or inference data using a common key;
transmitting, by the first user equipment, the encrypted training data and/or the encrypted inference data to a network node;
transmitting, by the network node, the encrypted training data and/or the encrypted inference data to a second user equipment; and
decrypting, by a second machine learning model of the second user equipment, the encrypted training data and/or the encrypted inference data using the common key, and performing machine learning using the decrypted training data and/or the decrypted inference data.

6. The communication method according to claim 5, wherein
the encrypting includes encrypting, by a data collector of the first machine learning model, the training data and the inference data using the common key, and
the decrypting includes decrypting, by a data collector of the second machine learning model, the encrypted training data and/or the encrypted inference data using the common key.

7. A communication method in a mobile communication system, comprising the steps of:
transmitting, by a network node, a program for executing machine learning to a first user equipment and a second user equipment;
encrypting, by the first user equipment, training data and/or inference data using a common key created from the program, and transmitting the encrypted training data and/or the encrypted inference data to the network node;
transmitting, by the network node, the encrypted training data and/or the encrypted inference data to the second user equipment; and
decrypting, by the second user equipment, the encrypted training data and/or the encrypted inference data using the common key created from the program, and performing machine learning using the decrypted training data and/or the decrypted inference data.

8. The communication method according to claim 1, wherein
the network node is a base station or a core network node.
